(19) United States
(12) Patent Application Publication
(10) Pub. No.: US 2015/0047486 A1
(43) Pub. Date: Feb. 19, 2015

(54) QUICK CHANGE ABRASIVE WHEEL FOR RECIPROCATING KNIFE SHARPNER

(71) Applicants: John M. Davies, Willington, CT (US); Darryl C. Stein, Andover, CT (US)

(72) Inventors: John M. Davies, Willington, CT (US); Darryl C. Stein, Andover, CT (US)

(21) Appl. No.: 14/460,141

(22) Filed: Aug. 14, 2014

Related U.S. Application Data
(60) Provisional application No. 61/865,822, filed on Aug. 14, 2013.

(51) Int. Cl. B26D 7/12; B26D 1/06; B24B 3/36

(52) U.S. Cl. CPC B26D 7/12; B24B 3/361; B26D 1/065
USPC 83/174; 451/278; 451/559

(57) ABSTRACT

A spindle configured for a reciprocating knife sharpener is provided. The spindle includes a head including an arbor configured for manual exchange of abrasive material. A knife sharpener and a cutting table are disclosed.

### BACKGROUND OF THE INVENTION

1. Field of the Invention

The invention disclosed herein relates to a computer controlled machine tool having a reciprocating knife for cutting shapes of sheet material.

2. Description of the Related Art

Fabrication of large quantities of garments necessarily calls for cutting multiple components from sheets of material. For example, consider manufacturer that tends to produce a large number of identical garments. The manufacturer may increase production efficiency greatly by simultaneously cutting identical components from layered sheets of material.

Use of a computer controlled machine tool for cutting of the garment component shapes from stacked layers of fabric material is well known. Typically, such a machine tool includes a knife that is configured for performing the cutting. The cutting edge of the knife of the machine tool must be kept sharp to maintain the cut edge quality of the material shapes produced. Consequently, the machine tool typically includes a built-in sharpener for maintaining the cutting edge of the knife. Many apparatus and methods are available for sharpening the reciprocating knife of the machine tool.

At least one set of abrasive wheels are included in a traditional sharpening apparatus. Each abrasive wheel is fixed to the end of an axle which has an attached or integral pulley with a first bearing and second bearing, each forming a corresponding grinding spindle. The pair of opposing grinding spindles is held in a yoke. The grinding spindles are rotated through belt drives. The drive may be controlled by command of computer controller. Well known computer controlled cutting machine tools may command the yoke to pivot about an axis parallel to the long straight cutting edge of the reciprocating knife causing either the first or the second of the opposing grinding spindles to contact the cutting edge of the reciprocating knife. Traditional sharpening apparatus may use additional yokes and grinding spindles which may be stacked above the first set of grinding spindles in order to increase the width of the cutting edge that may be sharpened. Predictably, the abrasive wheels wear and must be periodically replaced.

A further complication with prior art sharpening apparatus is that the outer races of the bearings of the grinding spindles reside in fork shaped features of the yoke. These bearings are retained in the forks by an elastic round profile belt that is also utilized as the drive means for rotating the grinding spindles. In these traditional sharpening apparatus, an operator would remove each grinding spindle by stretching the elastic belt such that the bearings would separate free from the fork shaped features of the yoke. Next, the worn abrasive wheels are replaced on the axles of the grinding spindles. This operation further requires removal and reinstallation of threaded fasteners. A short coming of the traditional method is that stretching of the belt drive damages the belt thereby diminishing its performance as a drive mechanism.

Another problem with the traditional replacement method is that fork shaped feature provides a less than ideal means of supporting the bearings of the grinding spindle. Since the yoke does not fully surround the bearings, the fork is necessary for the removal of the grinding spindle. Another shortcoming of the traditional replacement method is that time must be spent to remove and reinstall the threaded fasteners that secure the abrasive wheels.

What are needed are methods and apparatus for quickly removing and replacing the abrasive wheels of a reciprocating knife sharpener, without removing the grinding spindles from the yokes. Preferably, the methods and apparatus provide for improving a manner by which the abrasive wheels may be quickly removed from the sharpener for replacement.

### SUMMARY OF THE INVENTION

In one embodiment, a spindle configured for a reciprocating knife sharpener is provided. The spindle includes a head including an arbor configured for manual exchange of abrasive material.

In some embodiments, the arbor includes at least one magnet. In some embodiments the head further includes a ferrous backing plate that includes an abrasive layer. In some embodiments, the head includes at least one phase lock feature with a corresponding phase lock complement. In some embodiments, the head includes at least one pin with a corresponding locating hole. In some embodiments, the spindle further includes at least one of a drive pulley and a timing pulley for driving the spindle; and in some instances, the timing pulley includes one of a set of grooves and a set of teeth disposed about a circumference thereof. In some embodiments, the head includes one of a hook-and-loop style fastener and a mushroom-type hook fastener.

In another embodiment, a knife sharpener for sharpening a reciprocating knife is provided. The knife sharpener includes at least one spindle configured for a reciprocating knife sharpener, the spindle including a head including an arbor configured for manual exchange of abrasive material.

In some of these embodiments, the at least one spindle is a pair of spindles with a first spindle and an opposing second spindle. The sharpener may include at least one spindle that includes two pairs of spindles, each of the pairs including a first spindle and an opposing second spindle. The sharpener may include a drive mechanism for driving the at least one spindle includes one of a belt drive and a timing belt drive. The sharpener may further include a drive mechanism that is configured for being controlled by a controller.

In yet another embodiment, a cutting table for cutting sheets of material is provided. The cutting table includes a control system for controlling a reciprocating knife configured to cut through the sheets of material; and, a knife sharpener for sharpening a reciprocating knife, the sharpener including at least one spindle configured for a reciprocating knife sharpener, the spindle including a head including an arbor configured for manual exchange of abrasive material.

In some of these embodiments, the sheets of material may include multiple layers of fabric. In some instances, the control system may be configured to provide automated production of work product. Further, in some instances, the control system may be configured to control the sharpening with the knife sharpener.

### BRIEF DESCRIPTION OF THE DRAWINGS

The features and advantages of the invention are apparent from the following description taken in conjunction with the accompanying drawings in which:

FIGS. 1A through 1D, collectively referred to herein as FIG. 1, depict aspects of a sharpener apparatus according to the teachings herein;

FIG. 2 is a cross-sectional view of a spindle as depicted in FIG. 1;

FIGS. 3A and 3B are exploded isometric views of a quick change apparatus for the spindle depicted in FIG. 2;

FIG. 4 is an isometric view of another embodiment of the sharpener apparatus disclosed herein;

FIGS. 5A and 5B, collectively referred to herein as FIG. 5, depict aspects of a spindle apparatus for the embodiment of FIG. 4; and,

FIG. 6 is an isometric view of a material cutting system that employs the sharpener apparatus disclosed herein.

### DETAILED DESCRIPTION OF THE INVENTION

Disclosed herein are methods and apparatus for improving the maintenance of, and, by extension, the performance of a reciprocating knife sharpener. The reciprocating knife sharpener generally includes at least one set of abrasive wheels that enable sharpening of a reciprocating knife. The reciprocating knife is particularly useful for cutting through multiple layers of material, such as layers of fabric that are to be incorporated into apparel.

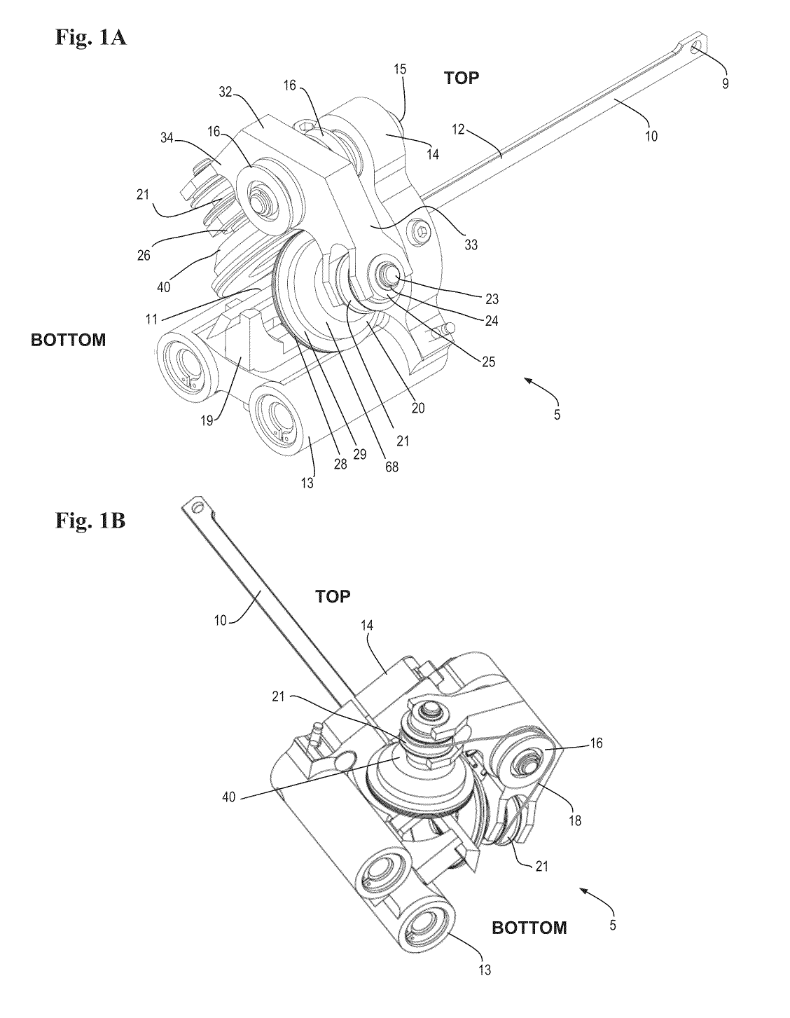

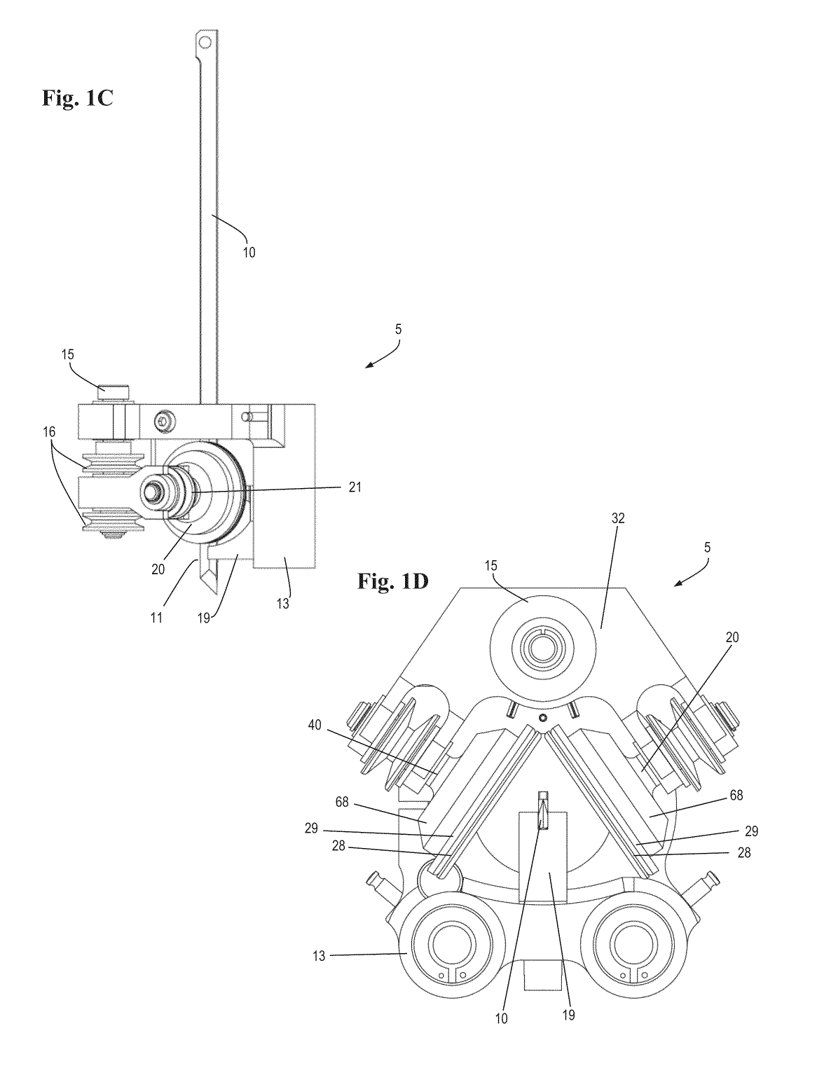

Refer now to FIG. 1, where aspects of an exemplary first embodiment of a knife sharpener 5 are shown. In this embodiment, the knife sharpener 5 includes a frame 13. The frame 13 supports a body 14 which is mounted thereto. The body 14 includes a shaft 15 disposed through a portion thereof. A bearing arrangement (not shown) allows the shaft 15 to rotate relative to the yoke 32, while the yoke 32 may also pivot independently. Yoke 32 provides for retention of a first spindle 20 and opposing second spindle 40.

Each one of the first spindle 20 in the opposing second spindle 40 are configured to drive a respective abrasive wheel 28 (which is referenced only on the first spindle 20 in the drawings). The opposing abrasive wheels 28 provide for sharpening of knife 10.

Generally, knife 10 includes at least one cutting edge 11 disposed onto blade 12. Knife 10 may include a mount for mounting the knife 10 into a chuck (not shown). In this example, knife 10 includes an eyelet 9. Generally, the frame 13 is configured for mounting of the knife sharpener 5 to another system, such as a computer controlled cutting table. The frame 13 may include cradle 19. Cradle 19 may be provided to provide a secure and stable bench for retaining the knife 10 during sharpening.

It should be noted that terms of orientation such as “top” and “bottom” as used herein are merely for purposes of discussion and ease in referencing the various elements. Terms of orientation are not to be construed as limiting of the teachings in any way.

Disposed on the shaft 15 are two drive pulleys 16. Generally, the drive pulleys 16 are driven by shaft 15, which is in turn driven by an external force of rotational energy (not shown). Turning of the drive pulleys 16 provides for driving of drive belt 18 (shown in FIG. 1B). In turn, drive belt 18 drives respective spindle pulleys 21. Rotation of the shaft 15 also causes the yoke 32 to pivot, causing either of the abrasive wheels 28 to contact the knife 10 and thus provide for sharpening of the cutting edge 11. Rotation of the shaft 15 as well as driving of the drive pulleys 16 may be controlled by a controller, such as a computer.

Each of the first spindle 20 and the second spindle 40 are mounted into a respective portion of yoke 32. As shown in FIG. 1A, first spindle 20 is mounted into a first arm 33 of yoke 32, well second spindle 40 is mounted into a second arm 34 of yoke 32. Generally, each spindle 20, 40 includes a first bearing 25 and a second bearing 26 disposed onto a central axle 23 about which the spindle 20, 40 will rotate. Disposed between the first bearing 25 and the second bearing 26 is the spindle pulley 21. Accordingly, rotation of each of the respective spindles 20, 40 is stable. In this example, each spindle 20, 40 is secured by a respective retaining clip 24. Retaining clip 24 provides for retention of a respective one of the first spindle 20 and the second spindle 40 within the respective portion of the yoke 32.

Disposed at a base of each spindle 20, 40 is arbor 68. Generally, arbor 68 provides for quick attachment and detachment of backing plate 29, and therefore abrasive layer 28 which is disposed on an opposite side of the backing plate 29. The arbor 68, the backing plate 29 and other elements such as the abrasive layer 28 are discussed further here in more detail.

Again, note that some of the foregoing elements are referenced only in the drawings with regards to the first spindle 20, however, these elements are common to the second spindle 40 as well.

FIG. 1C provides a side view of the knife sharpener 5. FIG. 1D provides a view of the knife sharpener 5 from the bottom. In this illustration, one may better view the relationship of the first spindle 20 with the second spindle 40 as well as the knife 10.

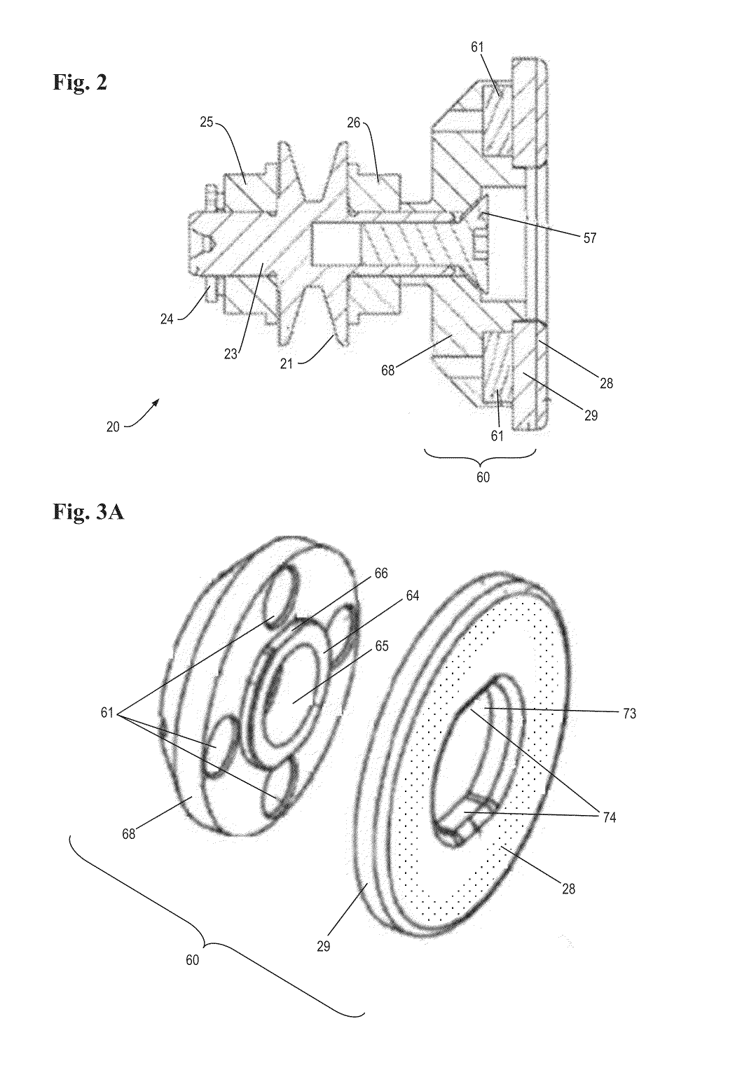

Referring now to FIG. 2, more detail regarding the quick change spindle 20 is shown. That is, FIG. 2 provides a cutaway side view of the spindle 20. As may be seen in this illustration, the spindle 20 includes a central axle 23. The spindle pulley 21 may be integrated into the central axle 23, or disposed over the axle 23 using techniques as may be known in the art. Disposed on a first side of the spindle pulley 21 is the first bearing 25, while the second bearing 26 is disposed on an opposite side of the spindle pulley 21. The first bearing 25 is retained on the axle 23 by virtue of retaining clip 24. While shown as retaining clip 24, this element may be any type of design or apparatus deemed appropriate for retaining the first bearing on the axle 23. Disposed to the right of the second bearing 26 (as depicted in FIG. 2) is arbor 68. The arbor 68 may be secured to the axle 23, for example, by fastener 57. In this example, the axle 23 includes a hollow portion into which fastener 57 may be threaded.

Disposed within a base of the arbor 68 is at least one magnet 61. Generally, the at least one magnet 61 (referred to hereafter simply as “magnet,” which is not meant to imply use of only one magnet) provides for quick attachment and detachment as well as secure retention of backing plate 29. Where the at least one magnet 61 is used in the arbor 68, the backing plate 29 includes a ferrous material that is attracted to the magnet 61, and therefore the backing plate 29 may be attached to the arbor 68 by operation of a magnetic field. Disposed on the exterior surface of backing plate 29 is abrasive layer 28.

In some embodiments, the at least one magnet 61 is a neodymium magnet. Other types of magnets may be used as deemed appropriate. Suitable abrasive materials include a monolayer of cubic boron nitrite that may be brazed to the backing plate 29, as well as a class of abrasives known as vitreous bond abrasives that may be adhered to the backing plate 29. In short, any abrasive material deemed appropriate for use in the abrasive layer 28 may be used.

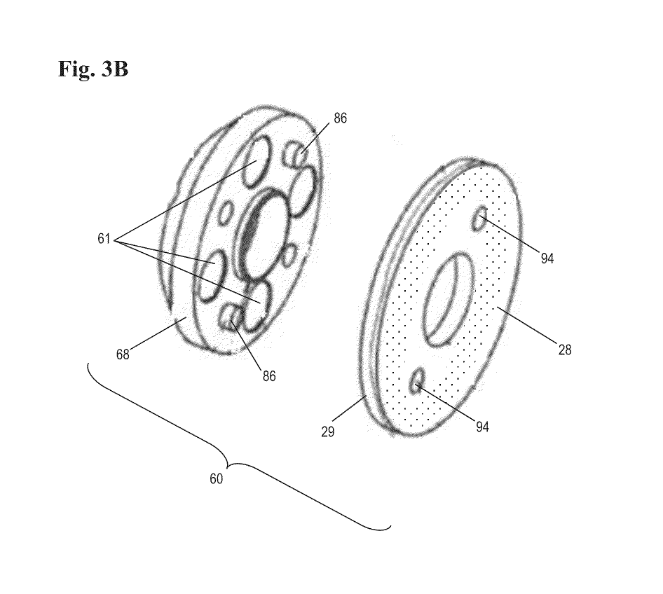

Collectively, the arbor 68 with the backing plate 29 disposed thereon may be referred to as an “arbor” 60. Aspects of two embodiments of the head 60 are presented in FIG. 3.

Referring to FIG. 3A, a first embodiment of the head 60 includes an embodiment of the arbor 68 that incorporates a collar 64 disposed about a central through-way 65. In this example, the collar 64 includes at least one phase lock feature 66. More specifically, in this example, the collar 64 includes a flattened portion of the circumference thereof. The backing plate 29 that is configured to mate with the arbor 68 also includes a through-hole 73. The through-hole 73 is sized to mate with the central through-way 65 of the arbor 68. The through-hole 73 includes at least one phase lock complement 74, such as a flat. Generally, the at least one phase lock complement 74 is configured to match the at least one phase lock feature 66 on the arbor 68. Accordingly, when the spindle 20, 40 is rotated, torque is reliably transmitted to the backing plate 29 and therefore the abrasive layer 28.

Referring to FIG. 3D, a second embodiment of the head 60 is shown. In this example, the arbor 68 includes at least one pin 86. Each of the at least one pin 86 cooperate with a respective locating hole 94 disposed in the backing plate 29. Accordingly, when the spindle 20, 40 is rotated, torque is reliably transmitted to the backing plate 29 and therefore the abrasive layer 28.

The permanent magnets and rotation driving features may be replaced with a hook-and-loop style fastener (not shown) or a mushroom-type hook fastener (not shown). In this case, the backing plate by 29 is not required to be a magnetic material, and the one or more phase locking features 66 are not a necessary component of the apparatus.

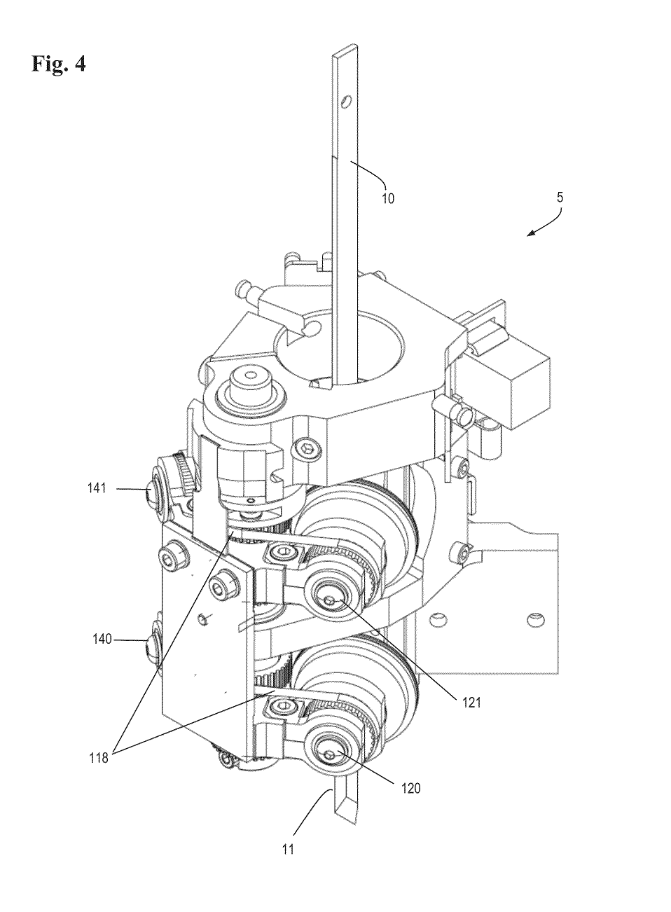

Referring now to FIG. 4, another embodiment of the knife sharpener 5 is shown. In this example, the knife sharpener 5 includes two sets of opposing spindles. That is, in this embodiment, the knife sharpener 5 includes a first timing spindle 120 that is paired with a second timing spindle 140. Additionally, the knife sharpener 5 includes a third timing spindle 121 that is paired with a fourth timing spindle 141. Each pair of the timing spindles is driven by a respective timing drive belt 118.

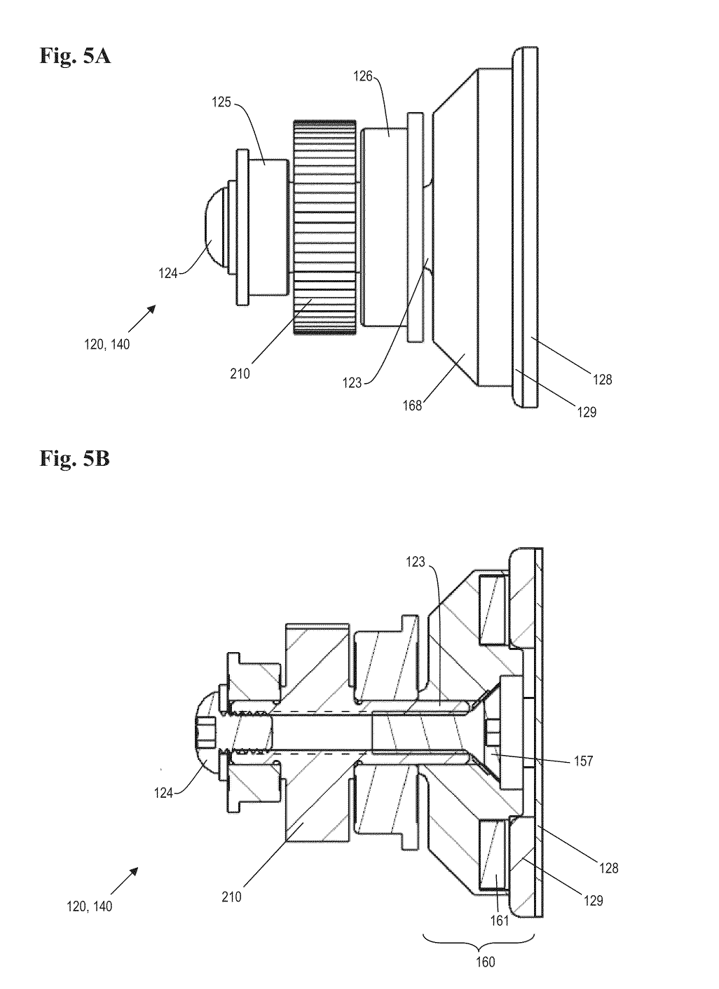

Referring now to FIG. 5, further detail regarding the timing spindles is provided. As shown in FIGS. 5A and 5B, the timing spindle 120, 140 includes a central axle 123. Disposed on the central axle 123 is a first bearing 125, a timing pulley 210, and a second bearing 126. Similar to the first embodiment, the first bearing 125 is retained in place by a retaining faster 124. The retaining faster 124 couples to the central axle 123. Similarly, the second bearing 126 is retained in place by hub 168 which is secured to axle 123 by fastener 157.

Generally, each timing pulley 210 includes a series of grooves or teeth disposed about a circumference thereof. Accordingly, the timing drive belt 118 includes surface features designed to cooperate with the grooves or teeth disposed on the timing pulleys 210. For purposes of convention, embodiments making use of timing pulleys 210 as well as timing drive belts 118 may be referred to as “timing configurations” and by other similar terms.

Generally, arbor 160 is of a construction that is similar to the first embodiment discussed above. That is, arbor 160 generally includes hub 168 with at least one magnet 161 disposed therein. Generally, the at least one magnet 161 provides for quick attachment and detachment as well as secure retention of backing plate 129. Disposed on the exterior surface of backing plate 129 is abrasive layer 128.

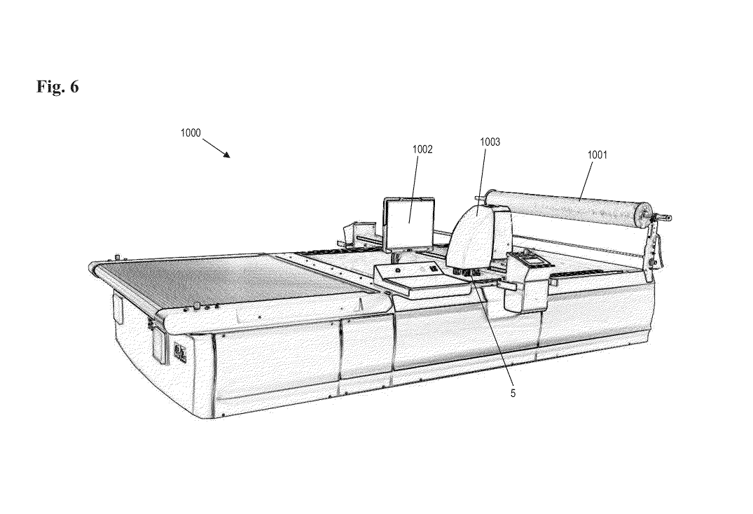

Referring now to FIG. 6, aspects of a cutting table 1000 are shown. The cutting table 1000 generally includes a supply of material such as fabric 1001. The fabric 1001 may be provided in multiple layers. The fabric 1001 may be drawn onto the cutting table 1000 by rollers and other such techniques as are known in the art. Drawing fabric 1001 onto the cutting table 1000 may be controlled by control system 1002. Control system 1002 generally provides a user interface for a system operator. Additionally, control system 1002 may include instruction sets (such as, for example, non-transitory machine executable instructions stored on machine readable media), the instructions for implementing a method or controlling a process.

Among other things, the control system 1002 may control a cutting system 1003. In this illustration, the cutting system 1003 is disposed within a housing. Knife sharpener 5 may be provided as a part of the cutting system 1003. The control system 1002 may receive instructions from an external input (such as a network, a library, or other such input) and guide the cutting system 1003 to provide for automated production of work product.

Having thus introduced embodiments of the invention, some additional aspects are now presented.

Advantageously, the teachings herein provide for exchange of spindle-mounted abrasives without removing a respective spindle from a knife sharpener. Accordingly, exchange may be made in a rapid fashion. Further, by not requiring a user to remove a respective spindle from the knife sharpener, it is possible to avoid stretching and degradation of drive belts. As a result, the design provided herein permits operators to make use of drive belts that impart greater torque than previously achievable. Thus, sharpening operations are expedited.

Generally, in order to exchange the abrasive media, an operator need only de-energized the knife sharpener, and then manually turn the yoke. Once the yoke has been turned and the media is exposed to the operator, the operator may remove the respective backing plates from their spindles and replace the used backing plates with new ones. The user may then release the yoke which will return to a resting position.

In general, a spindle that is designed in accordance with the teachings herein may be referred to as including a “quick change abrasive,” as having a “quick change arbor,” a “quick change head” and by other similar terms. Generally, a “quick change” apparatus provides for manual addition, exchange or replacement of abrasives without the need for additional tooling (such as a screwdriver, clip remover, wrench or the like).

As discussed herein, the term “reciprocating knife sharpener” generally refers to a knife sharpener useful for sharpening of reciprocating knives, such as those used in fabric cutting operations. The reciprocating knife sharpener may be controlled manually and/or by a control system. Generally, a reciprocating knife sharpener includes motor driven abrasives to provide for sharpening of the reciprocating knife.

Generally, a spindle according to the teachings herein is configured for being retained by and driven by apparatus associated with a reciprocating knife sharpener.

Elements disclosed herein may be arranged in any manner deemed appropriate. For example, with reference to FIG. 3B, the arrangement of pins 86 and locating holes 94 may be reversed such that the pins 86 are located on the backing plate 29 and the locating holes are disposed on the arbor 68. In short, a number of variations may be realized while remaining within the scope and the spirit of the teachings herein.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Standards for performance for any of the embodiments disclosed herein are to be judged according to the needs or preferences of a user, designer, manufacturer, or other similarly interested party. No limitations are to be inferred from the description provided herein.

Various other components may be included and called upon for providing for aspects of the teachings herein. For example, additional materials, combinations of materials and/or omission of materials may be used to provide for added embodiments that are within the scope of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A spindle configured for a reciprocating knife sharpener, the spindle comprising:
a head comprising an arbor configured for manual exchange of abrasive material.

2. The spindle as in claim 1, wherein the arbor comprises at least one magnet.

3. The spindle as in claim 1, wherein the head further comprises a ferrous backing plate comprising an abrasive layer.

4. The spindle as in claim 1, wherein the head comprises at least one phase lock feature with a corresponding phase lock complement.

5. The spindle as in claim 1, wherein the head comprises at least one pin with a corresponding locating hole.

6. The spindle as in claim 1, further comprising at least one of a drive pulley and a timing pulley for driving the spindle.

7. The spindle as in claim 6, wherein the timing pulley comprises one of a set of grooves and a set of teeth disposed about a circumference thereof.

8. The spindle as in claim 1, wherein the head comprises one of a hook-and-loop style fastener and a mushroom-type hook fastener.

9. A knife sharpener for sharpening a reciprocating knife, the sharpener comprising:
at least one spindle configured for a reciprocating knife sharpener, the spindle comprising a head comprising an arbor configured for manual exchange of abrasive material.

10. The sharpener as in claim 9, wherein the at least one spindle comprises a pair of spindles with a first spindle and an opposing second spindle.

11. The sharpener as in claim 9, wherein the at least one spindle comprises two pairs of spindles, each pair comprising a first spindle and an opposing second spindle.

12. The sharpener as in claim 9, wherein a drive mechanism for driving the at least one spindle comprises one of a belt drive and a timing belt drive.

13. The sharpener as in claim 9, further comprising a drive mechanism that is configured for being controlled by a controller.

14. A cutting table for cutting sheets of material, the cutting table comprising:
a control system for controlling a reciprocating knife configured to cut through the sheets of material; and,
a knife sharpener for sharpening a reciprocating knife, the sharpener comprising at least one spindle configured for a reciprocating knife sharpener, the spindle comprising a head comprising an arbor configured for manual exchange of abrasive material.

15. The cutting table as in claim 14, wherein the sheets of material comprise multiple layers of fabric.

16. The cutting table as in claim 14, wherein the control system is configured to provide automated production of work product.

17. The cutting table as in claim 14, wherein the control system is configured to control the sharpening with the knife sharpener.
